(19) United States
(12) Patent Application Publication
(10) Pub. No.: US 2009/0293661 A1
(43) Pub. Date: Dec. 3, 2009

(54) SHIFT APPARATUS OF AXIALLY MOVING SHAFT

(75) Inventors: Norio KAYUKAWA, Okazaki-shi (JP); Kazutaka Kobayashi, Nishio-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI CO., LTD., Nishio-shi (JP)

(21) Appl. No.: 12/473,584

(22) Filed: May 28, 2009

(30) Foreign Application Priority Data
May 29, 2008 (JP) 2008-141347

(51) Int. Cl. F16H 61/32

(52) U.S. Cl. 74/473.12

(57) ABSTRACT

A shift apparatus of an axially moving shaft includes a worm wheel engaging with a worm shaft, an electric motor driving the worm wheel, and an axially moving shaft including a rack engaging with a pinion fixed to the worm wheel for moving the axially moving shaft in first and second directions, a movement of the axially moving shaft in at least one of the first direction and the second direction is stopped by a portion of the axially moving shaft making contact with a portion of the casing, the worm shaft of which both axial ends are supported by the casing to be rotatable and axially movable, the worm shaft being biased by a spring in at least one of the first direction and the second direction and elastically retained at a position within an operating area of the worm shaft in the first direction and the second direction.

### CROSS REFERENCE TO RELATED APPLICATIONS

This application is based on and claims priority under 35 U.S.C. §119 to Japanese Patent Application 2008-141347, filed on May 29, 2008, the entire content of which is incorporated herein by reference.

### FIELD OF THE INVENTION

The present invention relates to a shift apparatus of an axially moving shaft.

### BACKGROUND

A known transmission is disclosed in JP2000-291796A, for example. The transmission disclosed includes a shift drum and shift fork shafts. The shift drum including a cam groove on an outer periphery is driven to rotate via a worm gear by means of an electric motor controlled by an ECU (electronic control unit). Each of the shift fork shafts including a driven cam that engages with the cam groove reciprocates in an axial direction of the shift fork shaft so as to select and change gears via a shift fork.

According to the transmission disclosed in JP2000-291796A, each of the shift fork shafts reciprocates in the axial direction via the worm gear and a cam mechanism constituted by the cam groove and the driven cam by means of the electric motor. In this case, the cam mechanism may be omitted to obtain a structure as illustrated in FIG. 3. In FIG. 3, a worm wheel 37 and a worm shaft 4 engaging with each other are rotatably supported by a transmission casing 1. Axial end portions of the worm shaft 4 are supported by the transmission casing 1 via respective roll bearings 5. One of the axial end portions of the worm shaft 4 is connected to an output shaft 6a of an electric motor 6 via a coupling 7 to thereby cause the worm wheel 37 to rotate in both clockwise and counterclockwise directions (i.e., cause the worm wheel 17 to rotate in a reciprocating manner). Axial end portions of a fork shaft 35 are supported via bushes 3 by retention bores 2a and 2b, respectively, which are formed at portions of an inner peripheral surface of the transmission casing 1 facing each other so that the fork shaft 35 is slidable in an axial direction thereof. The fork shaft 35 moves to both sides in the axial direction (i.e., the fork shaft 35 reciprocates) while a rack 35a formed at a portion of the fork shaft 35 is engaging with a pinion 38 coaxially fixed to the worm wheel 37. Then, a fork 36 provided at the fork shaft 35 selects and changes gears. In order to prevent a displacement of a gear set, through which a power transmission is executed, in the axial direction, the fork 36 is required to stop at an accurate position. Thus, one axial end of the fork shaft 35 makes contact with a bottom surface 2c of the retention bore 2a or the other axial end of the fork shaft 35 makes contact with a bottom surface 2d of the retention bore 2b so that the axial movement of the fork shaft 35 is stopped and consequently the fork shaft 35 is appropriately positioned. The structure illustrated in FIG. 3 is provided as a comparative example only and may not be disclosed in any documents.

According to the structure shown in FIG. 3, the movement of the fork shaft 35 is instantaneously stopped when one axial end of the fork shaft 35 makes contact with the bottom surface 2c of the retention bore 2a or the other axial end of the fork shaft 35 makes contact with the bottom surface 2d of the retention bore 2b. The worm wheel 37 is also instantaneously stopped. Then, rotations of the worm shaft 4 and the motor 6 are stopped. In this case, however, because of rotary inertia of the worm shaft 4 and the motor 6, the rotations thereof are not immediately stopped. As a result, a tooth portion 4a formed in a helical manner at an outer periphery of the worm shaft 4 excessively engages with a tooth portion 37a formed at an outer periphery of the worm wheel 37 of which rotation is instantaneously stopped when the rotation of the fork shaft 35 is stopped. A tooth surface pressure generated between the tooth portion 4a of the worm shaft 4 and the tooth portion 37a of the worm wheel 37 engaging with each other increases significantly. Even if the motor 6 is powered to rotate in a reverse direction for returning (i.e., reversing) the fork shaft 35, the worm shaft 4 and the motor 6 are unable to rotate in the reverse direction because of a frictional force generated between the tooth portion 4a of the worm shaft 4 and the tooth portion 37a of the worm wheel 37. As a result, the fork shaft 35 may be impossible to reverse or return. Such problem may be resolved by an increase of a torque of the motor 6, however this may result in an increase in size and weight of the motor 6 and may raise a new problem of an increase of energy for operating the motor 6.

A need thus exists for a synchronous motor control device which is not susceptible to the drawback mentioned above.

### SUMMARY OF THE INVENTION

According to an aspect of the present invention, a shift apparatus of an axially moving shaft includes a worm wheel engaging with a worm shaft, the worm wheel and the worm shaft being rotatably supported by a casing, an electric motor driving the worm wheel to rotate in clockwise and counterclockwise directions via the worm shaft, and an axially moving shaft supported by the casing to be axially movable, the axially moving shaft including a rack that engages with a pinion coaxially fixed to the worm wheel for moving the axially moving shaft in a first direction and a second direction, a movement of the axially moving shaft in at least one of the first direction and the second direction is stopped by a portion of the axially moving shaft making contact with a portion of the casing. The worm shaft of which both axial ends are supported by the casing to be rotatable and axially movable, and the worm shaft is biased by a spring in at least one of the first direction and the second direction and elastically retained at a position within an operating area of the worm shaft in the first direction and the second direction.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a partially broken side view illustrating an entire structure of a shift apparatus of an axially moving shaft according to an embodiment of the present invention;

FIG. 2 is an enlarged cross-sectional view taken along line II-II in FIG. 1; and

FIG. 3 is a side view illustrating a comparative example of a shift apparatus of an axially moving shaft.

### DETAILED DESCRIPTION

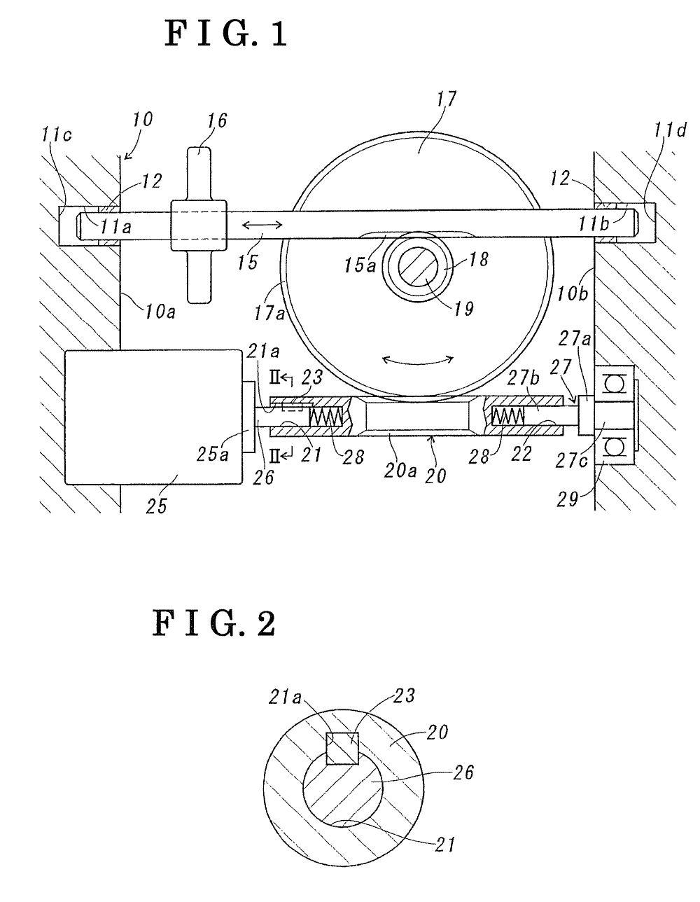

An embodiment of the present invention will be explained with reference to FIGS. 1 and 2. A shift apparatus of an axially moving shaft (hereinafter simply referred to as a shift apparatus) of the present embodiment is applied as, for example, a shift apparatus in an automated manual transmission. The shift apparatus includes a worm wheel 17, a worm shaft 20, and a fork shaft 15 serving as an axially moving shaft. The worm wheel 17 to which a pinion 18 is coaxially fixed is supported by a transmission casing 10 serving as a casing. The worm shaft 20 engaging with the worm wheel 17 is driven to rotate by an electric motor 25 so as to cause the worm wheel 17 to rotate in a reciprocating manner (i.e., operate the worm wheel 17 to rotate in both clockwise and counterclockwise directions). The fork shaft 15 is supported by the transmission casing 10 in an axially movable manner. In addition, the fork shaft 15 includes a rack 15a, with which the pinion 18 engages, so that the fork shaft 15 moves in a reciprocating manner, i.e., moves in axially one direction (i.e., a first direction) and the other direction (i.e., a second direction).

In FIG. 1, the worm wheel 17 to which the pinion 18 is coaxially fixed is coaxially provided at a support shaft 19 that extends in an orthogonal direction relative to the worm shaft 20 in a spaced manner. The support shaft 19 is rotatably supported by the transmission casing 10. Both axial ends (i.e., a first end and a second end) of the worm shaft 20 engaging with the worm wheel 17 are supported by an output shaft 26 serving as a first support shaft of the electric motor 25, of which operation is controlled by a controller, and a second support shaft 27, respectively. The motor 25 is assembled on an inner surface 10a of the transmission casing 10 in such a manner that the output shaft 26 is orthogonal to the support shaft 19 in a spaced manner. The second support shaft 27 is rotatably supported by an inner surface 10b of the transmission casing 10 via a ball bearing 29 so as to be coaxial to the output shaft 26 and axially away therefrom. The inner surfaces 10a and 10b of the transmission casing 10 face each other as illustrated in FIG. 1. The second support shaft 27 includes a flange portion 27a at an axial center, a base portion 27c supported by the ball bearing 29, and an end portion 27b extending to the output shaft 26 all of which are coaxially integrally arranged to one another.

As illustrated in FIG. 1, the first and second ends of the worm shaft 20 formed in a round bar shape as a whole are formed by first and second support bores 21 and 22, respectively, so as to be coaxial to each other. The output shaft 26 and the second support shaft 27 are axially slidably fitted to the support bores 21 and 22 so that the worm shaft 20 is axially movably supported by the transmission casing 10. The worm shaft 20 includes a helical-shaped tooth portion 20a at a center engaging with a tooth portion 17a of the worm wheel 17 while the worm shaft 20 is supported by the transmission casing 10 in the aforementioned manner.

As illustrated in FIGS. 1 and 2, a key groove 21a, which axially extends, is formed at the first support bore 21 of the worm shaft 20. Then, a sunk key 23 assembled on an end portion of the output shaft 26 engages with the key groove 21a. Thus, the output shaft 26 coaxially supports the first end of the worm shaft 20 in such a manner that the first end is axially movable (i.e., slidable) and to which rotations of the output shaft 26 are transmitted. On the other hand, the second support shaft 27 coaxially supports the second end of the worm shaft 20 so that the second end of the worm shaft 20 is rotatable and axially slidable. Springs 28 are arranged within the respective support bores 21 and 22. More specifically, the springs 28 are disposed between a bottom surface of the first support bore 21 and an end surface of the first support shaft 26 and between a bottom surface of the second support bore 22 and an end surface of the second support shaft 27. Because of these two springs 28, the worm shaft 20 is biased from axially both sides (i.e., first and second directions) and elastically retained at a substantially intermediate position within an operating area of the worm shaft 20 in the first direction and the second direction. When an external force is applied from either side in the axial direction, the worm shaft 20 moves in the corresponding direction to the external force against a biasing force of each of the springs 28. When the application of the external force is stopped, the worm shaft 20 returns to the intermediate position.

As illustrated in FIG. 1, retention bores 11a and 11b are coaxially formed at the inner surfaces 10a and 10b of the transmission casing 10, respectively. The both axial end portions of the fork shaft 15 are supported by the retention bores 11a and 11b, respectively, via respective bushes 12 so as to be slidable in the axial direction orthogonal to the support shaft 19 of the worm wheel 17. A fork 16 is fixed to a portion of the fork shaft 15 that engages with a sleeve so as to move the sleeve in the axial direction of the fork shaft 15. The rack 15a formed at a portion of the fork shaft 15 engages with the pinion 18. The sleeve, which is provided at a gear shift shaft, moves axially in both directions so as to selectively connect one of gears provided at both sides of the sleeve to the gear shift shaft, thereby changing gears.

In a non-operating state as illustrated in FIG. 1, the fork shaft 15 and the fork 16 are each in a neutral position. The sleeve engaging with the fork 16 so as to change gears is also in a neutral position. None of the gears provided at both sides of the sleeve are connected to the gear shift shaft and thus the power transmission is not satisfied. When the motor 25 controlled by the controller is driven to rotate in one direction (i.e., a first direction) to thereby rotate the output shaft 26, the worm shaft 20 also rotates via the key 23. Then, the fork shaft 15 axially moves via the worm wheel 17 and the pinion 18. In a case where the fork shaft 15 moves in the leftward direction in FIG. 1, the fork 16 and the sleeve engaging with the fork 16 both move in the leftward direction in FIG. 1. The gear at the left side of the sleeve is connected to the gear shift shaft to thereby achieve the power transmission through a corresponding gear set. When the motor is driven to rotate in the other direction (i.e., a second direction), the fork shaft 15 returns, i.e., moves to a position as in the non-operating state (i.e., an original position). Then, the connection between the gear at the left side of the sleeve and the gear shift shaft is released. In a case where the fork shaft 15 moves in the rightward direction in FIG. 1, the fork 16 and the sleeve also move in the rightward direction. The gear at the right side of the sleeve is connected to the gear shift shaft to thereby achieve the power transmission through a corresponding gear set. When thereafter the motor 25 is driven to rotate in the first direction, the fork shaft 15 returns, i.e., moves to the position as in the non-operating state (i.e., the original position). The connection between the gear at the right side of the sleeve and the gear shift shaft is released.

The gear set through which the power is transmitted should be stopped at an appropriate and accurate position for the secure power transmission. Accordingly, one axial end portion of the fork shaft 15 makes contact with a bottom surface 11c of the retention bore 11a or the other axial end portion of the fork shaft 15 makes contact with a bottom surface 11d of the retention bore 11b so that the axial movement of the fork shaft 15 is instantaneously stopped. The movement of the worm wheel 17 is also instantaneously stopped. Then, the rotation of the worm shaft 20 is stopped, accordingly. In this case, however, according to the present embodiment, the output shaft 26 and the second support shaft 27 are respectively fitted to the first and second support bores 21 and 22 coaxially formed at the axial both ends of the worm shaft 20 in such a manner that the worm shaft 20 is axially slidably supported by the transmission casing 10. Further, the springs 28 disposed between the bottom surfaces of the support bores 21 and 22, and the end surfaces of the output shaft 26 and the second support shaft 27, respectively, bias the worm shaft 20 in the both axial directions so that the worm shaft 20 is elastically retained at the intermediate position within the operating area of the worm shaft 20 in the first direction and the second direction. Thus, even when the worm wheel 17 is instantaneously stopped, each of the springs 28 is elastically deformed to cause the worm shaft 20 to move by a small distance in the axial direction. The rotation of the worm shaft 20 is therefore prevented from stopping instantaneously. As a result, an increase of a surface pressure generated between the tooth portion 20a of the worm shaft 20 and the tooth portion 17a of the worm wheel 17 caused by an excessive engagement therebetween may be restrained. An enlargement of the motor 25 for returning the fork shaft 15 in a direction towards its original position is not necessary, thereby decreasing energy for returning the fork shaft 15 by the motor 25.

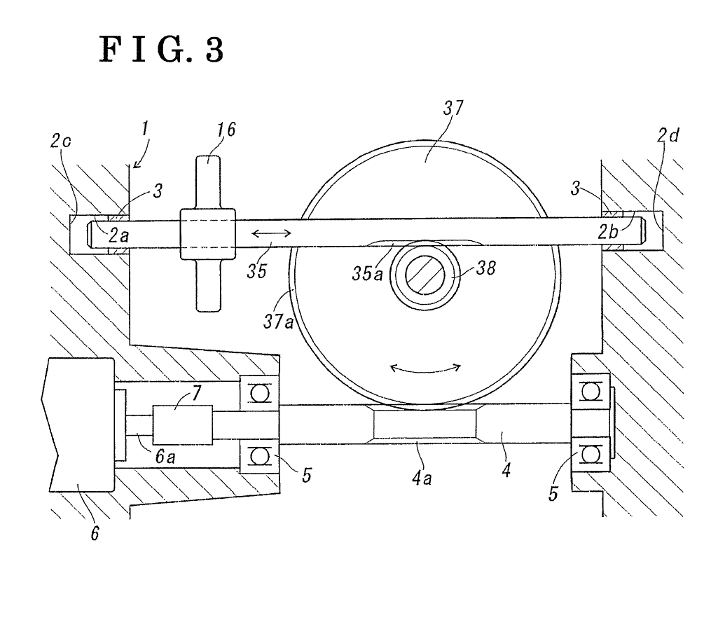

According to the aforementioned embodiment, the worm shaft 20 is supported to be axially movable by the output shaft 26 and the second support shaft 27 fitted to the first and second support bores 21 and 22, respectively, formed at the axial both ends of the worm shaft 20. Accordingly, only the worm shaft 20, excluding the first and second support shafts 26 and 27, moves by the small distance in the axial direction when the worm wheel 17 is instantaneously stopped. Thus, mass and inertia moment of a portion that moves by the small distance in the axial direction decrease, thereby further reducing the surface pressure generated between the tooth portion 20a of the worm shaft 20 and the tooth portion 17a of the worm wheel 17 caused by the excessive engagement therebetween. Consequently, energy for returning the fork shaft 15 in a direction towards its original position by the motor 25 is further reduced. In addition, according to the aforementioned embodiment, the first support shaft serves as the output shaft 26, and the springs 28 are disposed between the bottom surfaces of the support bores 21 and 22, and the end surfaces of the output shaft 26 and the second support shaft 27, respectively. Thus, a structure for supporting the worm shaft 20 and a structure for retaining the springs 28 are simply obtained, thereby simplifying a structure of the shift apparatus of the axially moving shaft as a whole, which leads to a decrease of a manufacturing cost thereof. However, the embodiment is not limited to have the aforementioned structure. For example, the worm shaft may include support shaft portions that extend at both axial ends as illustrated in FIG. 3. The worm shaft is supported by the transmission casing so as to be axially slidable by means of the support shaft portions. A coupling connecting the output shaft of the motor and one of the support shaft portions of the worm shaft is axially slidable. In addition, rotations of the motor are transmitted through the coupling. Alternatively, the springs 28 may be disposed between axial end surfaces of the worm shaft 20, and an end surface of a portion 25a of the motor 25 and an end surface of the flange portion 27a of the second support shaft 27, respectively, to thereby still achieve an effect of the aforementioned embodiment.

According to the aforementioned embodiment, the fork shaft 15 and the sleeve move from the neutral position to either side in the axial direction. Then, the gears provided at both sides of the sleeve are alternately or selectively connected to the gear shift shaft. Alternatively, the gear may be provided at one side of the sleeve and is selectively connected to the gear shift shaft. In this case, only one spring 28 is provided, being retained in an elastically compressed manner at a position within the operating area of the worm shaft 20 in one of the first direction and the second direction.

According to the aforementioned embodiment, the shift apparatus of the axially moving shaft is applied as the shift apparatus in the automatic transmission. Alternatively, the present embodiment is applicable to a shift apparatus of an axially moving shaft for moving a portion of a mechanical unit.

As mentioned above, in a case where a portion of the fork shaft 15 (axially moving shaft) makes contact with a portion of the transmission casing 10 to thereby immediately stop the rotation of the worm wheel 17, the tooth portion 20a formed at the outer periphery of the worm shaft 20 excessively engages with the tooth portion 17a formed at the outer periphery of the worm wheel 17 that is immediately stopped along with the immediate stop of the fork shaft 15. However, according to the aforementioned embodiment, the both axial ends of the worm shaft 20 are supported by the casing so as to be rotatable and axially movable and are biased by the spring 28 in at least one of the first direction and the second direction and elastically retained at a position within the operating area of the worm shaft 20 in the first direction and the second direction. Therefore, when the worm wheel 17 is immediately stopped, the spring 28 is elastically deformed, which leads to the worm shaft 20 to move by the small distance in the axial direction relative to the worm wheel 17. Accordingly, the increase of the surface pressure generated between the tooth portion 20a of the worm shaft 20 and the tooth portion 17a of the worm wheel 17 caused by the excessive engagement therebetween may be restrained. An enlargement of the motor 25 for returning the fork shaft 15 in a direction towards its original position is not necessary, thereby minimizing energy for returning the fork shaft 15 by the motor 25.

The shift apparatus further includes the output shaft 26 and the second support shaft 27 provided at the transmission casing 10 and coaxially arranged to each other while having a predetermined distance in the axial direction therebetween. The output shaft 26 coaxially supports the first end of the both axial ends of the worm shaft 20 to be axially slidable and to which rotations of the output shaft 26 are transmitted. The second support shaft 27 coaxially supports the second end of the both axial ends of the worm shaft 20 to be axially slidable. Two of the springs 28 are disposed between the first end of the worm shaft 20 and the output shaft 26, and between the second end of the worm shaft 20 and the second support shaft 27, respectively, for retaining the worm shaft 20 at the intermediate position within the operating area of the worm shaft 20 in the first direction and the second direction. The output shaft 26 is driven to rotate by the electric motor 25.

According to the aforementioned embodiment, only the worm shaft 20, excluding the first support shaft 26 and the second support shaft 27, moves by the small amount in the axial direction when the worm wheel is immediately stopped in a state where the worm wheel rotates in either direction, i.e., one of the clockwise direction and the counter clockwise direction. As a result, mass of a portion that moves by the small distance in the axial direction decrease, thereby further reducing the surface pressure generated between the tooth portion 20a of the worm shaft 20 and the tooth portion 17a of the worm wheel 17 caused by the excessive engagement therebetween. Energy for returning the fork shaft 15 in a direction towards its original position by the motor 25 is further reduced.

The shift apparatus further includes the first support bore 21 and the second support bore 22 formed at the first end and the second end of the worm shaft 20, respectively. The first support shaft serves as the output shaft 26 of the electric motor 25 which is attached to the transmission casing 10 and is axially slidably fitted to the first support bore 21. The second support shaft 27 of which the base portion 27c is supported by the transmission casing 10 and of which the end portion 27b is fitted to the second support bore 22 to be axially slidable. The springs 28 are disposed between the bottom surface formed at the first support bore 21 and the end surface formed at the output shaft 26 and between the bottom surface formed at the second support bore 22 and the end surface formed at the second support shaft 27.

Further, according to the aforementioned embodiment, a structure for supporting the worm shaft 20 is simply constituted by the first support shaft 26 and the second support shaft 27. The springs 28 are disposed within the first and second support bores 21 and 22, respectively, which prevents a special structure for retaining the springs 28. Consequently, a manufacturing cost of the shift apparatus may decrease.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A shift apparatus of an axially moving shaft, comprising:
a worm wheel engaging with a worm shaft, the worm wheel and the worm shaft being rotatably supported by a casing;
an electric motor driving the worm wheel to rotate in clockwise and counterclockwise directions via the worm shaft; and
an axially moving shaft supported by the casing to be axially movable, the axially moving shaft including a rack that engages with a pinion (coaxially fixed to the worm wheel for moving the axially moving shaft in a first direction and a second direction, a movement of the axially moving shaft in at least one of the first direction and the second direction is stopped by a portion of the axially moving shaft making contact with a portion of the casing;
the worm shaft of which both axial ends are supported by the casing to be rotatable and axially movable, the worm shaft being biased by a spring in at least one of the first direction and the second direction and elastically retained at a position within an operating area of the worm shaft in the first direction and the second direction.

2. The shift apparatus according to claim 1, further comprising a first support shaft and a second support shaft provided at the casing and coaxially arranged to each other while having a predetermined distance in an axial direction therebetween, the first support shaft coaxially supporting a first end of the both axial ends of the worm shaft to be axially slidable and to which rotations of the first support shaft are transmitted, the second support shaft coaxially supporting a second end of the both axial ends of the worm shaft to be axially slidable, wherein two of the springs are disposed between the first end of the worm shaft and the first support shaft and between the second end of the worm shaft and the second support shaft, respectively, for retaining the worm shaft at an intermediate position within the operating area of the worm shaft in the first direction and the second direction, and the first support shaft is driven to rotate by the electric motor.

3. The shift apparatus according to claim 2, further comprising a first support bore and a second support bore formed at the first end and the second end of the worm shaft, respectively, wherein
the first support shaft serves as an output shaft of the electric motor which is attached to the casing and is axially slidably fitted to the first support bore,
the second support shaft of which a base portion is supported by the casing and of which an end portion is fitted to the second support bore to be axially slidable, and
the springs are disposed between a bottom surface formed at the first support bore and an end surface formed at the first support shaft and between a bottom surface formed at the second support bore and an end surface formed at the second support shaft.
